(19) United States
(12) Patent Application Publication
(10) Pub. No.: US 2020/0409478 A1
(43) Pub. Date: Dec. 31, 2020

(54) Enhanced 2D/3D Mouse For Computer Display Interactions

(71) Applicant: Saras-3D, Inc., Allentown, PA (US)

(72) Inventors: Kalpendu Shastri, Orefield, PA (US); Soham Pathak, Allentown, PA (US); Bipin D. Dama, Bridgewater, NJ (US); Divyang Shah, Allentown, PA (US); Alan Leonhartsberger, Kempton, PA (US)

(73) Assignee: Saras-3D, Inc., Allentown, PA (US)

(21) Appl. No.: 16/977,689

(22) PCT Filed: Mar. 7, 2019
(86) PCT No.: PCT/US19/21070

§ 371 Date: Sep. 2, 2020

Related U.S. Application Data
(60) Provisional application No. 62/643,217, filed on Mar. 15, 2018.

(51) Int. Cl. G06F 3/0346; G06F 3/0354; G06F 3/0362; G06F 3/038; G06F 3/03

(52) U.S. Cl. CPC G06F 3/0346; G06F 3/03543; G06F 3/04817; G06F 3/0383; G06F 3/0325; G06F 3/0362

(57) ABSTRACT

A computer mouse for providing commands to create both two-dimensional (2D) and three-dimensional (3D) movements and manipulations of objects as projected on a 3D display. The computer mouse comprises an input device including conventional button/wheel and trackball controllers and a mode switch for toggling between 2D operation and 3D operation. The computer mouse also includes an external processor responsive to the command signals and mode signal from the input device, and functions to translate the received signals into cursor actions on an associated 3D display.

### CROSS-REFERENCE TO RELATED APPLICATIONS

This application claims the benefit of U.S. Provisional Application No. 62/643,217, filed Mar. 15, 2018 and herein incorporated by reference.

### TECHNICAL FIELD

The present invention relates to a computer mouse configured for use with a 3D display device and, more particularly, to a computer mouse that can be controlled to operate as either a 2D or 3D input device, based on either a Cartesian coordinate system or polar coordinate system.

### BACKGROUND OF THE INVENTION

A conventional computer cursor is manipulated by a mouse to move on the computer display in 2D and/or 3D using the Cartesian coordinate system. In the last few years, new versions of Windows systems, Web-based applications, and desktop software have dramatically changed to integrate the use of 2D and 3D together. Microsoft Windows Vista, Internet world mapping such as Google Earth, and CAD/CAM/CAE software are examples of such applications, where the traditional computer cursor, mouse, and input method which utilize the Cartesian coordinate system are no longer suitable for such new applications as they used to be before.

For example, the traditional computer cursor has no accurate, logical control of the exact angle or distance of movement in 2D; it is always moved in multiple, discrete steps until it reaches its target on the computer display. With 3D applications, the user loses the sense of orientation and can only see a deceiving projection of the cursor's position on the computer screen.

The traditional mouse does not help much in 3D applications, although there are some current products which have attempted to solve the mouse's limitations in 3D, but such products are far from being practical and intuitive. For example, the company 3DConnexion offers an input device to be controlled by the user's one hand while moving the mouse with the other hand, as described in their U.S. Pat. No. 7,215,323 entitled “Three-Dimensional Integrated Input Apparatus” and issued B. Gombert et al. on May 8, 2007

The traditional computer method utilizes the Cartesian coordinate system to move the cursor on the computer display, and also to provide positional information associated with the mouse's movement to the computer system, where this system has many disadvantages when used with the new 3D applications. For example, it is hard to accurately move an object on the computer display in 3D if the movement is not parallel to the x, y, and z-axes, and it is difficult to navigate on the computer display to a point that is not defined with x, y, and z coordinates.

Thus, given the advances in 3D displays and the ubiquitous presence of a computer mouse as an often-preferred input device, a need remains for an improved computer mouse that is able to easily work with a 3D display.

### SUMMARY OF THE INVENTION

The needs remaining in the prior art are addressed by the present invention, which relates to a computer mouse configured for use with a 3D display device and, more particularly, to a computer mouse that can be controlled to operate as either a 2D or 3D input device, based on either a Cartesian coordinate system or polar coordinate system.

In accordance with the present invention, a 2D/3D mouse is provided that is enabled to function as either a conventional (“2D”) mouse or, when paired with a 3D display device, as an input device that is capable of selecting and manipulating a device in three dimensions. In one embodiment, a 2D/3D mouse is implemented by “repurposing” a 2D mouse to provide 3D controls by translating known mouse actions (movements, “clicks”) into 3D-based commands. In this embodiment, the mouse remains located on a flat surface, as with a conventional mouse. In another embodiment, a 2D/3D mouse is implemented by lifting the mouse off of the flat surface to trigger switching into the 3D mode of operation.

Various embodiments of the present invention may be presented as a two-piece device, single-piece device, a wand, or the like.

An exemplary embodiment of the present invention takes the form of a computer mouse for providing commands to create both two-dimensional (2D) and three-dimensional (3D) movements and manipulations of objects as projected on a 3D display. Specifically, the computer mouse comprises an input device including a left-click command element, a right-click command element, and a scroll wheel command element (each for generating specific command signals based upon unique actions of each element), an underside translation mechanism responsive to planar x-y movements of the input device on a flat surface for generation location signals, and a mode switch for generating a mode signal for toggling between 2D operation and 3D operation. The computer mouse also includes an external processor responsive to the command signals, location signals, and mode signal from the input device, and functions to translate the received signals into cursor actions on an associated 3D display.

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 illustrates an exemplary 2D/3D mouse formed in accordance with the principles of the present invention;

FIG. 2 illustrates the mouse of FIG. 1 in combination with an external processor and 3D display device, showing the ability of the mouse to provide three-dimensional control of a cursor on the display device;

FIG. 3 contains a similar illustration as that of FIG. 2, where in this case the mouse has instructed the external process to perform rotational movements of a selected 3D object;

FIG. 4 illustrates an alternative configuration of the 2D/3D mouse as described in association with FIG. 2, where in this case an additional “selector” icon is provided on the display and controlled by the 2D/3D mouse to move selected images into and out of the plane of the display along a line-of-sight (LOS);

FIG. 5 illustrates an alternative embodiment of a 2D/3D mouse formed in accordance with the present invention, in this case the mouse including a control module and operational to enter 3D mode operation when lifted off of a reference surface;

FIG. 6 is a block diagram of an exemplary set of elements forming the control module of the mouse of FIG. 5;

FIG. 7 illustrates a portion of a 2D/3D mouse of yet another embodiment, where in this example the mouse as shown in FIG. 6 is further configured to include camera devices and IR LEDs;

FIG. 8 shows yet another embodiment of a 2D/3D mouse formed in accordance with the present invention, where this embodiment includes a two-piece arrangement in the form of a base unit and separate hand-held controller, the two pieces remaining joined for use as a conventional 2D mouse, and the hand-held controller operating as a stand-alone 3D controller when removed from the base unit;

FIG. 9 is a cut-away view of the hand-held controller of FIG. 8;

FIG. 10 is an alternative embodiment of the hand-held controller of FIGS. 8 and 9, in this case exhibiting a smaller size by eliminating the cameras from the device; and

FIG. 11 illustrates another arrangement of the alternative embodiment of FIG. 10, where the hand-held controller of FIG. 11 also includes a touch pad element.

### DETAILED DESCRIPTION

As will be discussed in detail below, the present invention relates to a computer mouse device that is able to manipulate objects appearing on a screen in three dimensions, including both movements within the Cartesian three-dimensional space and rotational movements.

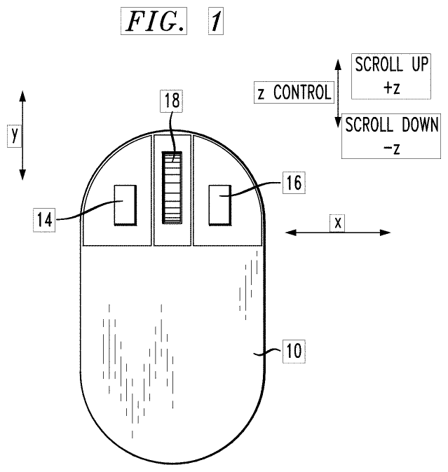

FIG. 1 illustrates a 2D/3D mouse 10 formed in accordance with one or more embodiments of the present invention. In this implementation 2D/3D mouse 10 comprises a conventional (i.e., “2D”) input device that is repurposed through external processor control to provide 3D functionality. For the purposes of the present invention, “3D functionality” includes: (1) the ability to move the screen cursor into and out of the x-y plane of the screen (that is, along the z-axis direction), (2) the ability to select a specific 3D object as displayed on the screen, and (3) the ability to manipulate the selected object in three dimensions, as well as rotate the selected object about all three axes.

Continuing with reference to FIG. 1, 2D/3D mouse 10 is shown as also including a “left-click” button 14, a “right-click” button 16, and a center wheel control 18 (for generating specific signals that control the actions of the cursor as displayed on the screen). While not explicitly shown, mouse 10 includes a trackball (or similar arrangement) that recognizes x- and y-direction movements of mouse 10 across a flat surface (such as, for example, a mouse pad). In one mode, therefore, 2D/3D mouse 10 is able to function as a traditional “2D” mouse, providing x-y control of a cursor as displayed on an associated computer screen. In accordance with the present invention, 2D/3D mouse 10 is further configured to toggle between operating in the 2D domain and the 3D domain.

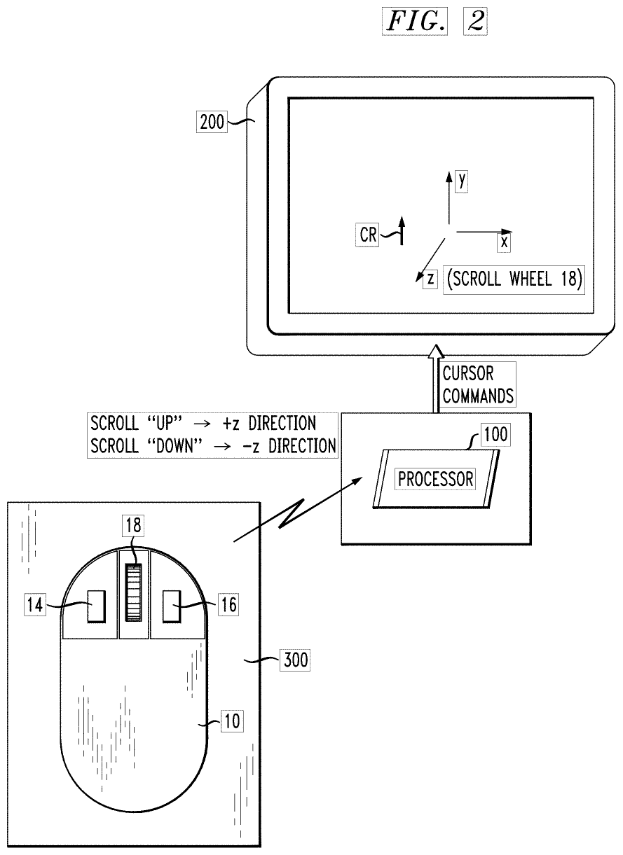

With reference to FIG. 2, an external processor 100 is utilized as an interface between 2D/3D mouse 10 and a 3D display screen 200 to provide three-dimensional control of objects represented on display screen 200 via manipulation of 2D/3D mouse 10. It is an aspect of the present invention that virtually any prior art conventional mouse (or other similar type of input device) may be repurposed via external processor 100 to provide such three-dimensional controls.

Referring to FIG. 2, it is presumed that 2D/3D mouse has been toggled to enter “3D mode”. This may be achieved, for example, by executing a “double click” of right-click button 16 (among various other means including, but not limited to activating a radio button on the display for switching between 2D/3D). In the view as shown in FIG. 2, mouse 10 is positioned as normal on a flat surface 300 (such as a table, mouse pad, etc.). And similar to its functionality as a two-dimensional device, when mouse 10 has been toggled to provide 3D commands, it controls a screen cursor CR to move along the x-axis direction and y-axis direction on display 200 by similar movements on flat surface 300. Three-dimensional movements along the z-axis direction are implemented in accordance with this embodiment of the present invention through the movement of center wheel control 18. In this case, an upward (forward) scrolling of wheel control 18 is understood by external processor 100 to correspond to a movement along the positive z-axis direction; that is, moving in the direction “out” of the display screen. Similarly, a downward (back) scrolling of wheel control 18 is understood by external processor 100 to correspond to a movement along the z-axis direction. Thus, in accordance with this embodiment of the present invention, mouse 10 is able to function to “select” a specific object on display 200 (using a traditional click of left button 14) and then move the selected object into and out of the screen by using center wheel control 18.

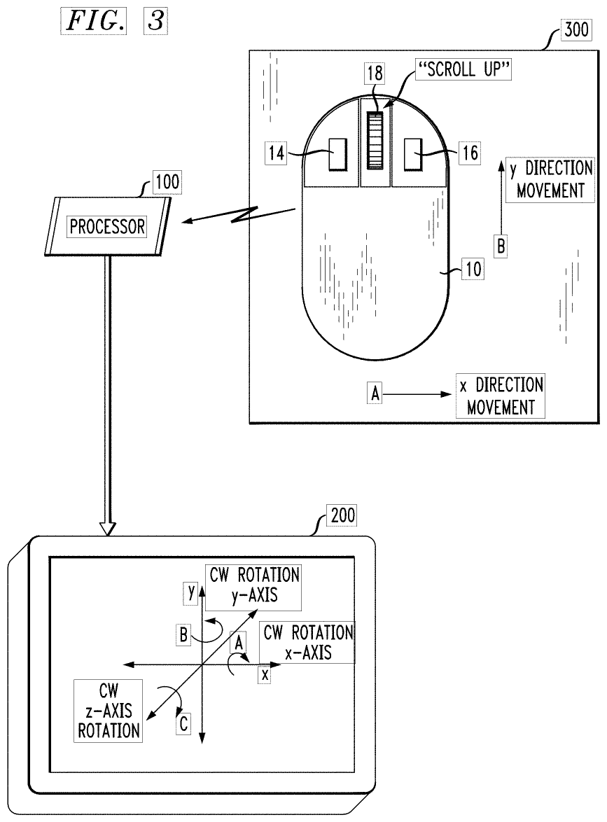

Rotation of a selected 3D object is now described with respect to FIG. 3. In accordance with the principles of the present invention, a unique command transmitted from mouse 10 to external processor 100 (or activation of an appropriate movement/rotation radio button on the display screen) is used to convert the mouse movements/clicks into specific rotational movements of the selected 3D object. For example, a simultaneous clicking of both buttons 14, 16 may be used to initiate rotational movement (many other combinations of clicks may be used for this purpose as well). Once external processor 100 has received the command to enter “3D rotational mode”, it will translate received signals from mouse 10 into specific rotational movements of the selected 3D object.

In an exemplary embodiment as shown in FIG. 3, a movement of mouse 10 along the positive x-axis direction on flat surface 300 (shown as arrow “A” on surface 300) is translated by external processor 100 into a clockwise rotation of the selected 3D object on display 200, shown here as arrow A depicting CW rotation around the x-axis direction. A movement of mouse 10 on flat surface 300 in the opposite direction is thus interpreted as a counter-clockwise rotation about the same x-axis direction. Rotations about the y-axis direction are similarly controlled by moving mouse 10 “up” (i.e., forward) and “down” (i.e., back) on flat surface 300. Here, an “up” movement of mouse 10 is shown by arrow B, where this movement is translated by processor 100 into a CW rotation of a selected 3D object in the y-axis direction on display 200. Intuitively, rotations about the z-axis direction (arrow C as shown in display 200) are controlled by the scrolling direction of center wheel control 18 of mouse 10.

Another configuration of the operation of 2D/3D mouse 10 is illustrated in FIG. 4. In this example, processor 100 has configured display 200 to show both cursor CR (conventional element, as well-known in the art and discussed above) as well as a separate and distinct “selector” icon SE. The initial movement of selector icon S will mimic the movements of cursor CR (as controlled by mouse 10). That is, if cursor CR moves to the left, selector SE will move to the left as well. In accordance with this aspect of the present invention, which selector SE has been positioned to hover over a given image (such as the flower shown in FIG. 4), the controls on mouse 10 can be used to move the given object in any direction. Importantly, the selection of the given image initiates processor 100 to move along the z-axis direction to define a “line-of-sight” (LOS) for that object. Selector SE, under the control of mouse 10, may then be used to move the given image “in” or “out” along the LOS.

Thus, in accordance with the embodiments of the present invention as described with respect to FIGS. 1-4, a conventional (2D) input device, such as a mouse controller, may be used in conjunction with an external processor (that performs conversion of mouse commands into cursor movements) to provide 3D manipulation of objects. There are many situations where for either economic or situational reasons it is not possible to purchase sophisticated three-dimensional input devices; the ability to repurpose existing input devices into a version that provides three-dimensional controls is significant. External processor 100 is used to toggle between two-dimensional and three-dimensional operations, as well as toggle between rotation and movement in three dimensions and provide control of an additional selector icon, when used.

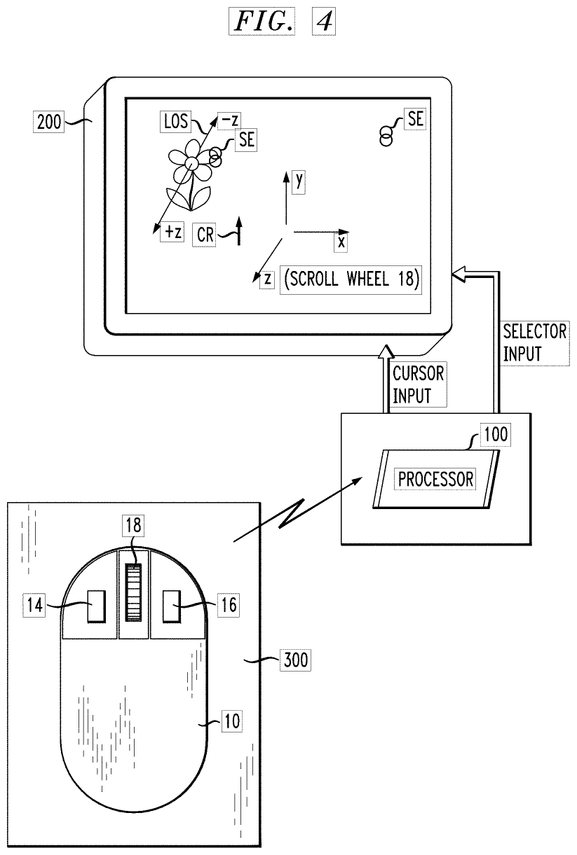

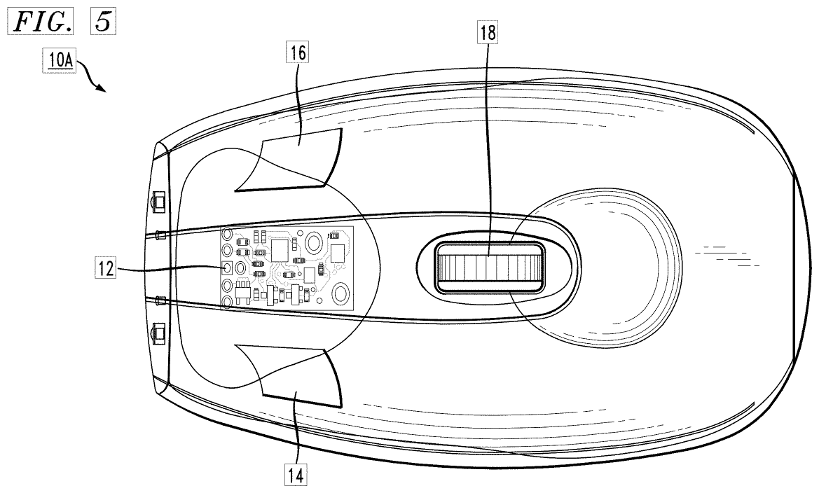

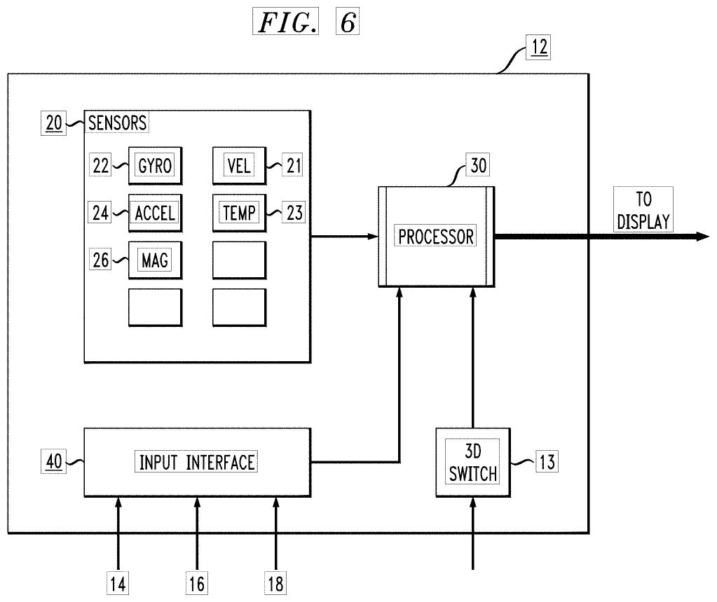

FIG. 5 illustrates an alternative embodiment of a 2D/3D mouse also formed in accordance with the teachings of the present invention. Shown as mouse 10A and as will be discussed in detail below, in this embodiment 3D movements are initiated by lifting mouse 10A off of flat surface 200. In particular, 2D/3D mouse 10A includes a control module 12 that is utilized to activate and control the three-dimensional operations of the mouse in the manner described in detail below with respect to FIG. 6. Mouse 10A is shown as also including left-click mouse button 14, right-click mouse button 16, and center control wheel 18. In accordance with the principles of this embodiment of the present invention, a significant aspect is the ability to utilize mouse 10A in either a conventional “2D” mode or a “3D” mode to provide additional types of movements and interactions with a display device. As mentioned above, the 3D control is activated by lifting mouse 10 off of its flat support surface (creating a hand-held controller).

FIG. 6 shows, in block diagram form, an exemplary set of components associated with control module 12. In particular, control module 12 is shown as including a 3D switch sensor 13 that recognizes when mouse 10A loses contact with flat surface 200, and a sends a message to included processor 30 to switch to “3D mode”. In this 3D mode, movement of mouse 10A in x, y, and z directions result in movement of the cursor through similar vectors, with rotation of mouse 10A resulting in rotation of a selected object on the display.

Control module 12 also comprises a plurality of sensors 20 that are used to define spatial aspects of the position and movement of mouse 10A in three dimensions with respect to a computer display that the mouse is controlling. In the embodiment of FIG. 6, the plurality of sensors 20 is shown as including a gyroscope 22, an accelerometer 24 and a magnetometer 26, where these sensors are used in combination to measure and record movements of mouse 10A, and then convert these movements into the proper type of actions required to interact with an associated 3D display and the displayed cursor or object. Magnetometer 26 functions as a compass within mouse 10A, detecting the orientation of mouse 10 with respect to Earth's magnetic north pole. Thus, for the purposes of orientation, magnetometer 26 is able to provide a constant and consistent reference point and does not experience drift over time. However, magnetometer 26 is not sufficiently responsive to quick movements and is unable to accurately measure these movements.

Gyroscope 22 is able to react quickly and accurately to such movements and small changes in direction. Inasmuch as the readings generated by gyroscope 22 accumulate considerable position error over time (i.e., “drift”), the use of magnetometer 26 to provide a consistent reference point for gyroscope 22 allows for the pair of combined sensors to function well together. Accelerometer 24 functions in a known manner to measure changes in the velocity of movement of mouse 10A (i.e., its “acceleration”). With additional processing capability, accelerometer 24 may also measure a change in position of mouse 10A (for example, by integrating the measured “change in velocity” received signal). As will be discussed below, other embodiments of a control module used in accordance with the present invention may utilize a separate velocimeter. Accelerometer 24 is also used in accordance with the present invention to provide an indication of the absolute orientation of mouse 10A in the “UP/DOWN” plane.

The various measurements obtained by sensors 20 are thereafter applied as inputs to a processor 30 included within control module 12. Processor 30 utilizes this information to maintain a defined relationship between mouse 10A and an associated computer display, as well as create commands to be transmitted to a display interface portion of an associated computer (not shown). Also shown in FIG. 6 is an input interface unit 40, which receives control signals from left-click button 14, right-click button 16 and center wheel 18. As with the embodiment discussed above in association with FIGS. 1-4, center wheel 18 may be used to move the cursor displayed on the screen in the z-direction (i.e., into and out of the screen), providing a 3D effect. Input interface unit 40 receives the scrolling input from center wheel 18, and provides this signal to processor 30. In turn, processor 30 translates the scrolling movement of wheel 18 into z-direction movements of a cursor (or selected object). While not explicitly shown, it is to be understood that processor 30 may be further configured to display one or more “selector” icons that may be used to provide LOS movement and manipulation of selected items in the manner previously discussed with respect to FIG. 4.

As mentioned above, the plurality of sensors 20 within control module 12 may include additional types of sensors. For example, a velocity detector 21 may be included in module 12 and configured to accurately measure the velocity of the mouse's movement through a change in air resistance as measured by a MEMS sensor, thereby determining the position in x, y, and z directions. Additionally, a temperature sensor 23 may be included within the plurality of sensors 20 and utilized to detect changes in the temperature of the user's hand (perhaps indicative of the user's state of mind, for example).

FIG. 7 is a close-up view of an end portion of an exemplary mouse 10B, where in this embodiment mouse 10A as shown in FIG. 5 (and including control module 12 as shown in FIG. 6) is further configured to include one or more cameras 50 that are used to provide an imaging signal link between a computer display screen and mouse. In particular, camera(s) 50 may be used to detect motion by comparing a camera image (or a marker in a camera image). The video signals from camera(s) 50 are provided as inputs to processor 30 within control module 12, where in this embodiment processor 30 contains additional video capabilities.

One or more IR LEDs 60 may also be included on mouse 10B, as shown in FIG. 7, and used to interact with established reference points on an associated display screen. Indeed, the screen position detection may be further enhanced by including markers on the screen frame at one or more corners (or along edges) of the display.

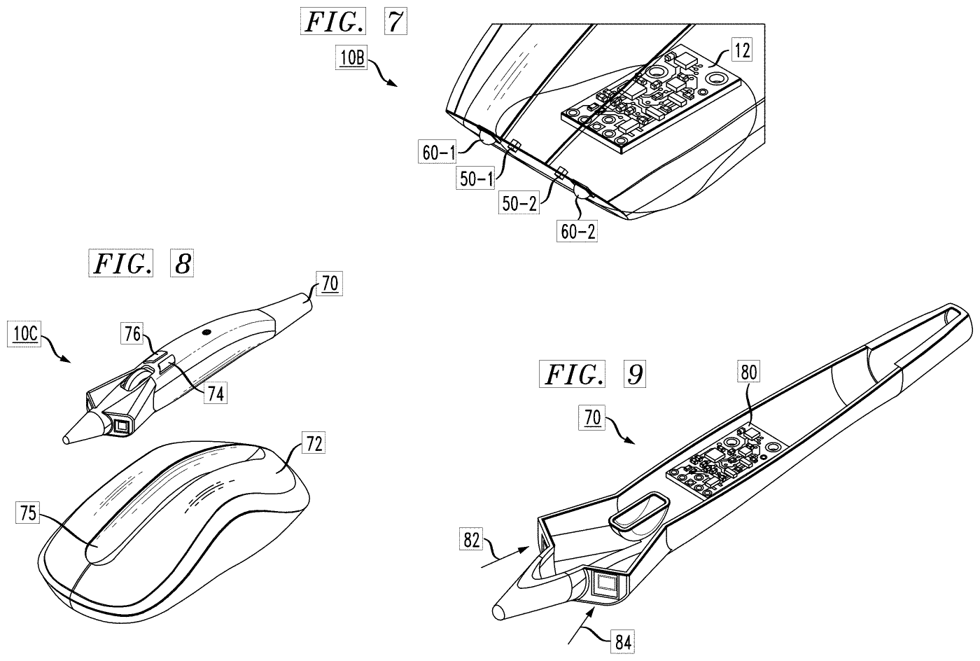

FIGS. 8 and 9 illustrate yet another embodiment of the present invention. In this embodiment, a 2D/3D mouse 10C formed in accordance with the present invention comprises two separate components: a mouse device 70 and a base support unit 72. Base support unit 72 is particularly configured to include conventional track-ball control (or similar device) that detects x-y movement of mouse 10C on a flat surface. Mouse device 70 itself is a self-contained device, including a “left-click” button 74, a “right-click” button 76, and central control wheel 78. A control module 80 (shown in FIG. 9) is included within mouse device 70 and functions in like manner to control module 12 discussed above in association with FIG. 6.

In one configuration, mouse device 70 may be positioned within a channel 75 (or alternative type of “releasable” fixing feature) formed in base support unit 72. When mouse device 70 is so engaged with base support 72, the combination functions to provide conventional two-dimensional mouse operations. In this configuration, it is also possible to perform three-dimensional cursor and object control features, using the same methodology as described above in association with FIGS. 1-4 (i.e., by scrolling central wheel 76). In further accordance with this embodiment, instead of lifting the entire device to perform a “3D” mode of operation, as described above with mouse 10B in association with FIGS. 5-7. only mouse device 70 needs to be lifted. That is, the motion of disengaging mouse device 70 from base support unit 72 is used as a “mode switch” signal, sent to control module 12. FIG. 8 illustrates mouse device 70 as used in its hand-held form to provide 3D control of a display.

In accordance with this embodiment of the present invention, mouse device 70 is configured as a low-profile type of hand-held controller that is easily manipulated to provide the various types of three-dimensional movements of a cursor and/or objects on an associated computer display. Various ones of the “environmental sensors” (e.g., gyroscope, temperature sensor, accelerometer, velocity detector, magnetometer, and the like) are embedded within controller 80 and used in the manner described above to provide the desired interactions with a 3D display. Cameras 82, 84 are shown as included in mouse device 70 and used for similar purposes as discussed above. Additionally, mouse device 70 may be configured to include one or more IR LEDs.

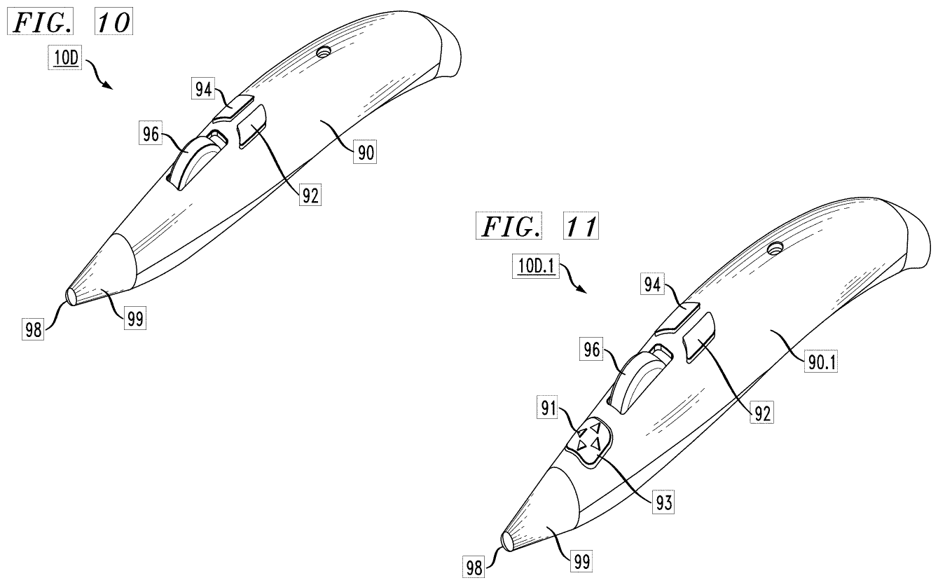

FIG. 10 illustrates an alternative 2D/3D mouse 10D (also referred to at times as “wand 90”). In comparison to mouse device 70 of FIGS. 7 and 8, wand 90 is slimmer in profile, where this is possible by the elimination of cameras from the controller. Wand 90 retains a left-click button 92, a right-click button 94, and a central control wheel 96. An IR LED 98 is positioned at a front tip 99 of wand 90. While not evident in the view of FIG. 10, it is to be understood that wand 90 includes a control module 12 having similar components to those described above.

A variation of wand 90 is shown as 2D/3D mouse 10D.1 in FIG. 11, this variation referred to as wand 90.1. The buttons, control wheel, and IR LED are the same as those shown in FIG. 10 and carry the same reference numerals. Wand 90.1 is shown to further comprise a touch pad 91 that may be used to control the movement of the cursor (similar to a touchpad on a PC), with a set of four indicators 93 definition the “up/down”, “left/right” cursor movements that may be employed.

It is to be understood that the specific embodiments, arrangements and methods described herein are merely illustrative of the principles of the present invention. Numerous modifications in form and detail may be mode by those of ordinary skill in the art without departing from the scope of the present invention. Indeed, the subject matter of the present invention is limited only by the scope of the claims appended hereto.

What is claimed is:

1. A computer mouse for providing commands to create both two-dimensional (2D) and three-dimensional (3D) movements and manipulations of objects as projected on a 3D display, the computer mouse comprising
an input device including
a left-click command element, a right-click command element, and a scroll wheel command element, each for generating specific command signals based upon unique actions of each element;
an underside translation mechanism responsive to planar x-y movements of the input device on a flat surface for generation location signals; and
a mode switch for generating a mode signal for toggling between 2D operation and 3D operation; and
an external processor responsive to the command signals, location signals, and mode signal from the input device, the external processor functioning to translate the received signals into cursor actions on an associated 3D display.

2. The computer mouse as defined in claim 1 wherein the mode switch functions by receiving a specific action from the command elements, so as to toggle between 2D mode and 3D mode without lifting the input device from the flat surface.

3. The computer mouse as defined in claim 2 wherein when operating in 3D mode, the scroll wheel command element generates command signals that are used by the external process to generate cursor movement signals for moving a cursor along a z-axis direction into and out of the 3D display.

4. The computer mouse as defined in claim 2 wherein the external processor is configured to recognize a specific command signal for switching between 3D translation commands and 3D rotational commands upon selection of a specific object for manipulation.

5. The computer mouse as defined in claim 4 wherein 3D rotational commands are associated with 3D translation commands such that movement of the input device in the x-axis direction on the flat surface rotates the specific object about the x-axis in a clockwise/counterclockwise direction as a function of movement to the left or to the right, movement of the input device in the y-axis direction on the flat surface rotates the specific object about the y-axis in a clockwise/counterclockwise direction as a function of the movement forward or back, and scrolling the scroll wheel forward and back rotates the specific object about the z-axis in a clockwise/counterclockwise direction as a function of forward and back movements.

6. The computer mouse as defined in claim 2 wherein the external processor is further configured to generate a separate selector icon for projection on the 3D display screen, wherein movements of the input device when in 3D mode also control the movements of the selector icon.

7. The computer mouse as defined in claim 6 wherein the processor is further configured to recognize a hovering action of the selector icon as a selection of a specific object and utilize z-axis information to generate a line-of-site reference for the specific object.

8. The computer mouse as defined in claim 1 wherein the mode switch comprises a pressure-sensitive element that recognizes the lifting of the input device off of a flat surface, the lifting action causing the pressure-sensitive element to transmit a 2D/3D mode control signal to the external processor.

9. The computer mouse as defined in claim 8 wherein the pressure-sensitive element comprises a pressure sensor.

10. The computer mouse as defined in claim 8 wherein the input device further comprises a control module including a plurality of sensors for defining spatial movements of the input device and transmitting changes in position and orientation of the input device to the external processor, for use in generating 3D cursor control signals for the 3D display.

11. The computer mouse as defined in claim 10 wherein the plurality of sensors comprises
a gyroscope for sensing changes in orientation in a 3D space;
an accelerometer for sensing changes in movement; and
a magnetometer for providing a true North reference for use by the gyroscope and the accelerometer.

12. The computer mouse as defined in claim 11 wherein the input device further comprises at least one camera for collecting imaging information from the 3D display and transmitting the imaging information to the external processor.

13. The computer mouse as defined in claim 11 wherein the input device further comprises a plurality of IR LEDs for interacting with registration icons on the 3D display to create a frame of reference for use by the external processor.

14. The computer mouse as defined in claim 8 wherein the input device comprises a two-part device including a base support unit for remaining located on the flat surface and a removable mouse device, wherein the control module is disposed within the removable mouse device.
